(19) United States
(12) Patent Application Publication
(10) Pub. No.: US 2009/0023462 A1
(43) Pub. Date: Jan. 22, 2009

(54) Signal Waveform Construction for Position Determination by Scrambled Conical

(75) Inventor: Paul Wilkinson Dent, Pittsboro, NC (US)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 11/778,728

(22) Filed: Jul. 17, 2007

(51) Int. Cl. H04Q 7/22

(52) U.S. Cl. 455/456.5

(57) ABSTRACT

A method and apparatus for determining a mobile station's location using an antenna beam that traverses a scan pattern is described herein. In one embodiment, a device transmits/receives a signal as a position of a transmission/reception antenna beam traverses the scan pattern in a non-sequential order. A strength of the received signal is measured at a plurality of the beam positions. After reordering the signal strength measurements, the mobile station location relative to a nominal center of the beam is determined based on the reordered signal strength measurements. Another embodiment uses signals having different frequency components that are transmitted or received in beams executed in different scan patterns. In this embodiment, signal strength measurements associated with different frequency components are jointly processed to determine a combined correlation. The relative mobile station location is determined based on the combined correlation.

### BACKGROUND

The present invention relates generally to determining a location of a mobile station within a wireless network, and more particularly to determining the mobile station's location relative to a position of an antenna beam.

Conventional satellite systems may track non-geostationary satellites from a ground station using a reception antenna beam that traverses a conical scan pattern in a sequential order. Conical scan patterns comprise angular offset directions, e.g., 0°, 45°, 90°, 135°, 180°, 225°, 270°, and 315°. As the ground station transmits a signal, the satellite moves the reception beam in the sequential order around the conical scan pattern according to the offset directions and measures the strength of the signal received at each offset direction. The variations in the measured signal strength for each offset direction have a phase and amplitude relationship to the location of the ground station relative to a nominal center of the reception beam, where the nominal center is equivalent to the center of the scan pattern. Thus, appropriately processing the signal strength measurements yields the direction and amount of offset of the beam center from the true ground station location.

Scanning antenna systems originally operated by mechanically rotating some part of the antenna, such as the feed horn at the focus of a parabolic reflector. Mechanically rotating systems typically require a smooth scanning motion. Digital beamforming provides an alternate solution that generates a scanning beam using a beamforming computer local to the antenna array or remote from the antenna array, as described in the following US patents to Applicant, which are hereby incorporated by reference herein:
U.S. Pat. Nos. 5,555,257, 5,619,503, 5,812,947, 5,848,060, 6,157,811
and U.S. Pat. No. 5,631,898, which are entitled “Cellular/satellite communications system with improved frequency re-use;”
U.S. Pat. No. 5,594,941 entitled “A cellular/satellite communications system with generation of a plurality of sets of intersecting antenna beams;”
U.S. Pat. No. 5,619,210 entitled “Large phased-array communications satellite;”
U.S. Pat. No. 5,642,358 entitled “Multiple beamwidth phased array;”
U.S. Pat. No. 5,909,460 entitled “Efficient apparatus for simultaneous modulation and digital beamforming for an antenna array;” and
U.S. Pat. No. 6,404,821 entitled “Digital beamformer for receiving a first number of information signals using a second number of antenna array elements.”

Conventional location systems work well for geostationary satellite systems communicating with stationary transmitter devices, e.g., ground stations, because in these cases the signal strength variations mostly result from moving the reception beam according to the conical scan pattern. However, when the satellite communicates with a mobile device, the signal may experience signal strength variations due to other factors, such as distortion caused by slow fading. Such distortion-based signal strength variations degrade the accuracy of the location determination process. Further, the above-discussed conventional systems only allow for the determination of the transmitter location. In some cases, it may be desirable to determine a receiver location. Thus, there remains a need for alternative location determination techniques.

U.S. Pat. No. 6,684,071 to Applicant et al., entitled “Terminal position location using multiple beams” and incorporated herein by reference, provides one alternative technique for finding a location of a receiver. The 071 patent measures the relative signal strengths of signals transmitted in neighboring antenna beams with different centers but overlapping coverage, where the overlapping beams use different communication channels to avoid mutual interference. The receiver cycles around the different communication channels to receive the signals and generate the corresponding signal strength measurements. In some systems, however, the ability to create multiple neighboring beams on different frequencies may be limited by power or spectrum availability. One alternative uses a given amount of power and spectrum to sequentially create one beam at a time. In this case, the strength of the signal at the receiver is measured at different times. As a result, the relative signal strength measurements may be corrupted by fading in the intervening periods. Thus, there remains a need for alternative location determination techniques that are less sensitive to corruption by fading effects.

### SUMMARY

The present invention determines the location of a mobile station in a wireless network using signals transmitted or received in antenna beams that traverse a scan pattern having a plurality of beam offset directions, referred to herein as beam positions. According to one embodiment, a network device transmits a signal to a mobile station as a position of a transmission antenna beam traverses a scan pattern in a non-sequential order. The mobile station measures a strength of the received signal at a plurality of the beam positions. After processing, which exploits spectral spreading of noise components of the received signal, the location of the mobile station relative to a nominal center of the transmission antenna beam is determined based on the signal strength measurements.

In one exemplary embodiment, a network device receives a signal from a mobile station as a position of a reception antenna beam traverses a scan pattern in a non-sequential order. The network device measures the strength of the received signal at a plurality of the beam positions and spreads a noise component of the signal strength measurements by, for example, reordering the signal strength measurements. After spreading the noise component, the network device determines the location of the mobile station relative to a nominal center of the reception antenna beam based on the reordered signal strength measurements.

Another embodiment uses multi-frequency signals or a signal with multiple subcarriers, (e.g., Orthogonal Frequency Division Multiplexing (OFDM) signals) to determine the location of the mobile station. In this embodiment, a network device generates first and second signals associated with first and second frequencies, respectively. The network device transmits the first and second signals to the mobile station as respective first and second transmission antenna beams execute first and second scan patterns. The first and second scan patterns may comprise, for example, a common scan pattern executed according to first and second orders or at different scanning frequencies. The mobile station measures a strength of the received first and second signals at a plurality of the beam positions of the respective scan patterns. Subsequently, a series of first and second signal strength measurements are jointly processed to determine a combined correlation with the respective scan patterns. The location of the mobile station is determined relative to a nominal center of the transmission antenna beam based on the combined correlation.

According to another exemplary multi-frequency embodiment, the network device receives the first and second signals from the mobile station as respective first and second reception antenna beams execute respective first and second scan patterns, which may comprise a common scan pattern executed in respective first and second orders or at different scanning frequencies. The network device measures a strength of the received first and second signals at a plurality of the beam positions of the respective scan patterns. Subsequently, the network device jointly processes the first and second signal strength measurements to determine a combined correlation with the respective scan patterns. The location of the mobile station relative to a nominal center of the reception antenna beam is then determined based on the combined correlation.

### BRIEF DESCRIPTION OF THE DRAWINGS

FIG. 1 shows a satellite communication system according to the present invention.

FIGS. 2A and 2B show exemplary beamforming systems for forming an electronically steerable antenna beam.

FIG. 3 shows a conical scan pattern having a plurality of beam positions executed in a sequential order.

FIG. 4 shows one exemplary conical scan pattern having a plurality of beam positions executed according to a non-sequential order.

FIG. 5 shows a block diagram for an exemplary wireless communication system comprising a network device and a mobile device.

FIG. 6 shows a flow chart for one exemplary location determination process.

FIG. 7 shows a block diagram for one exemplary location processor.

FIG. 8 shows a flow chart for another exemplary location determination process.

FIG. 9 shows one exemplary conical scan pattern executed in different sequential orders for beams associated with signals at different frequencies.

FIG. 10 shows another exemplary conical scan pattern executed in different non-sequential orders for beams associated with signals at different frequencies.

FIG. 11 shows one exemplary beamforming system for transmitting signals at different frequencies using multiple electronically steerable antenna beams.

FIG. 12 shows a set of signal strength measurements for signals associated with different frequencies.

### DETAILED DESCRIPTION

The present invention uses phase and amplitude information derived from a signal associated with an antenna beam traversing a predetermined scan pattern to determine the location of a mobile station relative to a nominal center of the beam, where the nominal center of the beam generally corresponds to the center of the scan pattern. The location determining process of the present invention may be implemented with any wireless network having a network device capable of generating an electronically steerable transmission and/or reception beam 130.

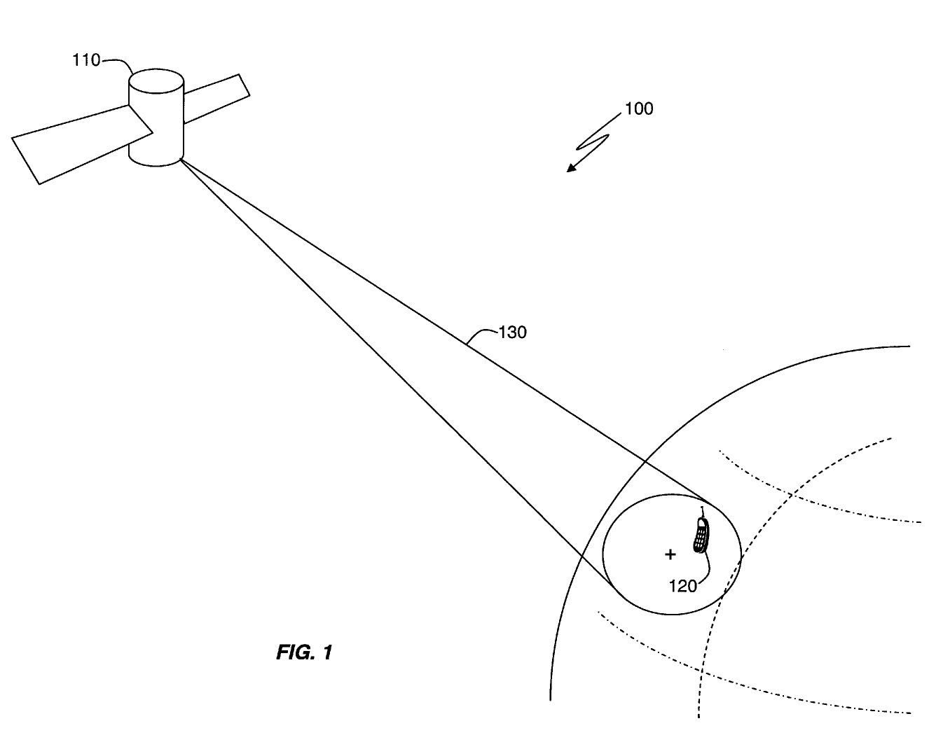

FIG. 1 shows an exemplary wireless network 100 comprising a network device 110 communicating with a mobile station 120 via an electronically steerable antenna beam 130. While FIG. 1 shows a beam 130 that covers a circular surface area, it will be appreciated that other surface areas, e.g., elliptical surface areas, are also applicable.

When the network device 110 comprises a satellite, an antenna array comprising a plurality of antenna elements transmits signals to and receive signals from the mobile station 120. The transmitted signal contains repetitive features that can be detected by a receiver, such as a frame with a frame repetition period, timeslots within the frame, and symbols within the time slot. Alternatively, the signal may comprise non-repetitive features, such as a long CDMA spreading code. It will be appreciated that the repetitive and non-repetitive features are synchronized between the network device 110 and the mobile station 120 so that both have a common agreement on “system time” that may be used to time events, such as the instant that a beam 130 moves from a first position to a second position.

The antenna array may comprise any electronically steerable antenna array, e.g., a directly-radiating phased array, a feed array disposed near the focus of a parabolic reflector, etc. The path from the i^{th} antenna element to the j^{th} mobile station 120 may be described by a matrix of complex coefficients Cⱼᵢ, while the path from the j^{th} mobile terminal 120 to the i^{th} antenna element may be described by a matrix of complex coefficients Cᵢⱼ. Thus, a matrix of complex coefficients may be used to define a pointing direction and other characteristics of a beam 130 communicating with the mobile station 120. These matrices are not necessarily reciprocal, as the forward and reverse link channel frequencies may be different.

The antenna array electronically steers the antenna beam 130 to a desired position based on the matrix of complex coefficients. The antenna array may also steer the beam 130 to a plurality of positions associated with a scan pattern, e.g., 0°, 90°,180°, and 270° in the case of a conical scan pattern. In this case, a cyclic set or ring of complex coefficient matrices is generated, where each complex coefficient matrix in the ring corresponds to one beam position in the scan pattern.

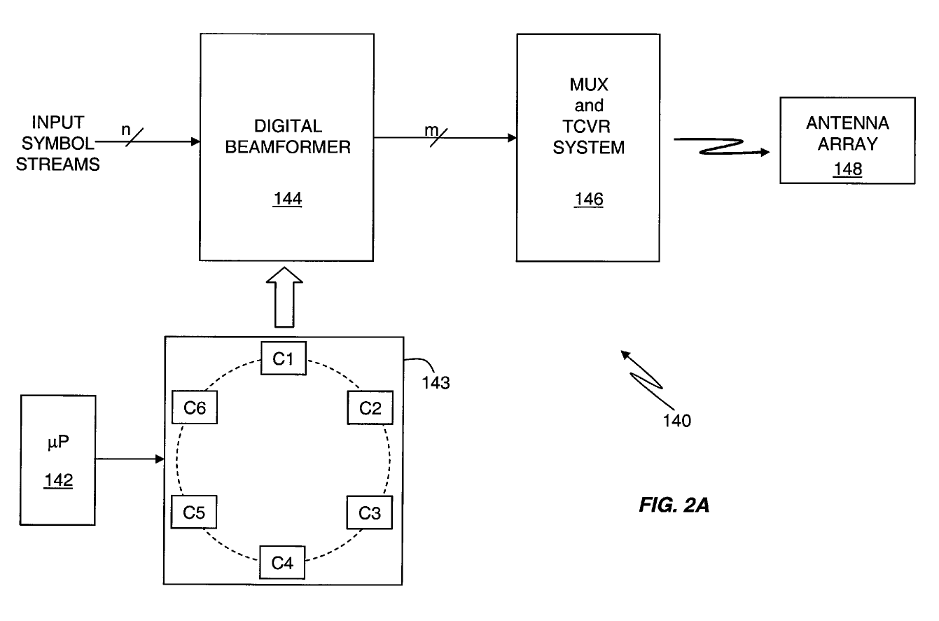

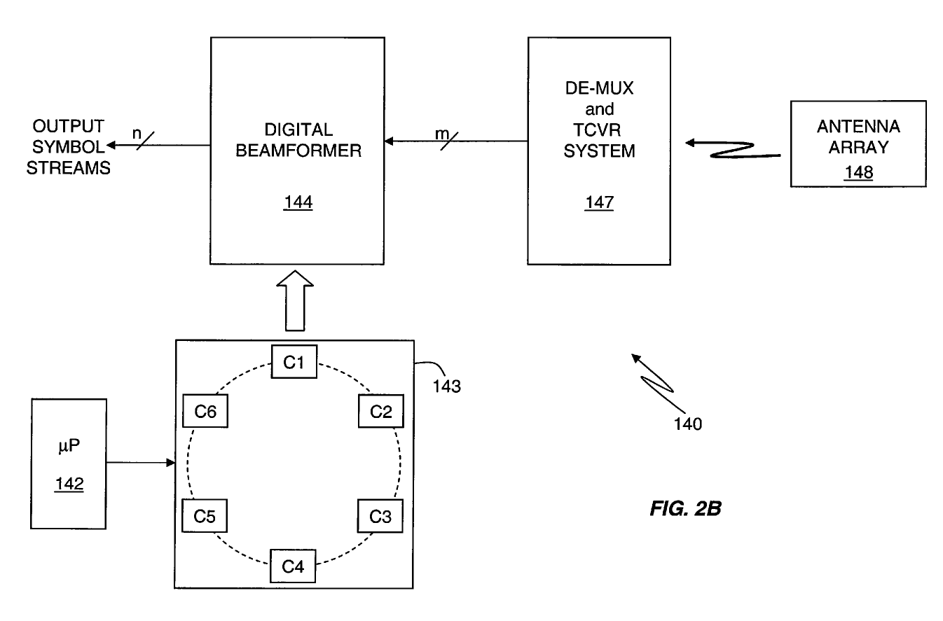

FIG. 2A shows one exemplary beamforming system 140 that electronically steers a transmission beam 130 according to a predetermined conical scan pattern. Beamforming system 140 comprises a processor 142, beamformer 144, and multiplexer and transceiver system 146. Processor 142 generates the scan pattern and a corresponding ring of complex coefficient matrices 143. In one example, the coefficient matrices 143 may be pre-computed and stored in look-up tables. Beamformer 144 accepts the ring of coefficient matrices 143 and forms weighted combinations with one or more input symbol streams using coefficient sets chosen from the ring of coefficient matrices 143. The multiplexer and transceiver system 146 combines the weighted combinations for each mobile station 120 and transmits the resulting antenna control signal to a remote antenna array 148. The remote antenna array 148 creates the antenna beam 130 and moves the antenna beam 130 to the beam positions of the conical scan pattern responsive to the antenna control signal. U.S. Pat. Nos. 5,909,460, 6,219,375, and 6,404,821, which are hereby incorporated by reference, describe exemplary methods for performing the complex matrix multiplication. U.S. Pat. No. 5,594,941, which is incorporated herein by reference, describes an exemplary method for transmitting the antenna control signal to the remote antenna array 148. It will be appreciated that pre-computed combinations of one or more of the symbol streams with the ring of coefficient matrices 143 may be stored in look-up tables to reduce the processing power associated with the beamforming process when the coefficient matrices do not change for some number of information symbols. It will further be appreciated that the beamforming system 140 may be located in a terrestrial base station at the bottom of an antenna mast. In this case, the multiplexer and transceiver system 146 may be replaced with a modulation and amplifier system (not shown).

The beamforming system 140 may also be used to generate reception antenna beams 130, as shown by FIG. 2B. Reception beamforming system 140 comprises a processor 142, beamformer 144, and de-multiplexer and transceiver system 147. The reception beamforming system 140 causes a signal transmitted by the mobile station 120 to be received by beams 130 having variable beam positions created by the receive beamforming system 140 in conjunction with the antenna array 148, where the different beam positions are set sequentially to different positions within the scan pattern.

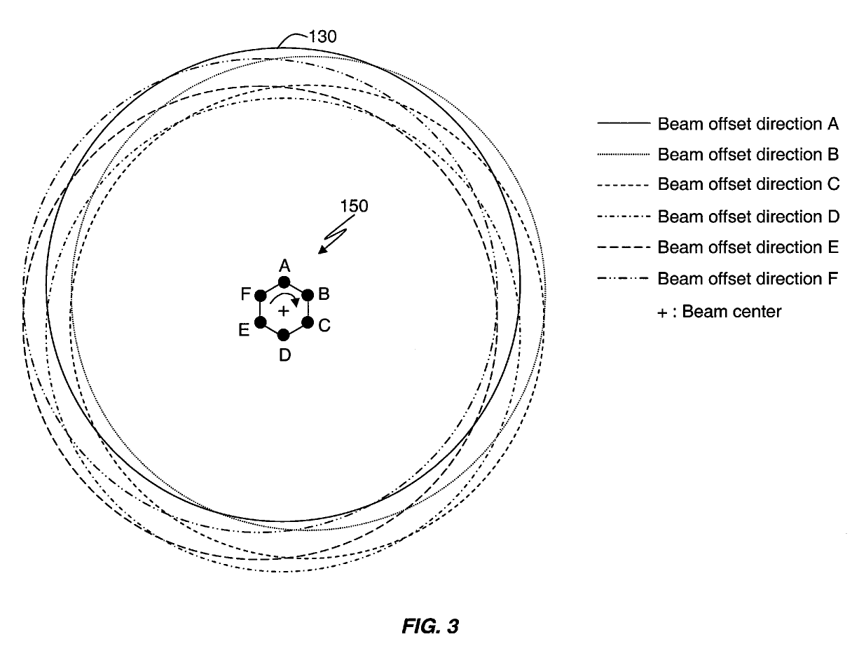

In conventional systems, beam forming system 140 generates a beam 130 that executes a conical scan pattern 150 in a sequential order. This is because, traditionally, the scan pattern was implemented by mechanically wobbling the antenna, which generally required a smooth wobble, such as that created by a constant speed rotation. FIG. 3 shows one exemplary conical scan pattern 150 having six beam offset directions (A-F), which are referred to herein as beam positions. The conical scan pattern 150 comprises a set of spaced angular beam positions, e.g., 0°, 60°, 120°, 180°, 240°, and 300°. The angular positions are not required to be evenly spaced. According to conventional systems, the position of the beam 130 traverses the conical scan pattern 150 by moving sequentially from position A to position B, from position B to position C, etc. As the beam 130 traverses the conical scan pattern 150, the beam 130 creates the illustrated wobble pattern.

When the transmission power is constant, scanning the beam 130 in this manner creates predictable signal strength variations relative to a nominal center of the beam 130. However, signals transmitted or received via antenna beam 130 may experience signal strength variations due to a number of causes other than beam scanning. For example, the measured signal strength may vary due to power control variations at the transmitter or due to noise, such as distortion in the form of slow fading. Such non-beam scanning signal strength variations change the strength of a received signal, which in turn may affect the accuracy of the determined location of the mobile station 120.

The power control variations may be eliminated by fixing the transmission power for a particular frame and/or set of time slots associated with the scan pattern. For example, the beam may be wobbled through its sequence of scanning directions during a period of time having a fixed transmission power, such as during the timeslots of a TDMA frame or during a sequence of TDMA frames over which the power control is held fixed. However, such power control does not address the signal strength variations due to slow fading or other channel noise. To address this problem, one embodiment of the present invention uses a non-sequential traversal of a conical scan pattern 150 to reduce the effect of slow fading of the received signal, and therefore, to reduce the effects of fading, which is a form of multiplicative noise, on the process of determining the location of the mobile station 120.

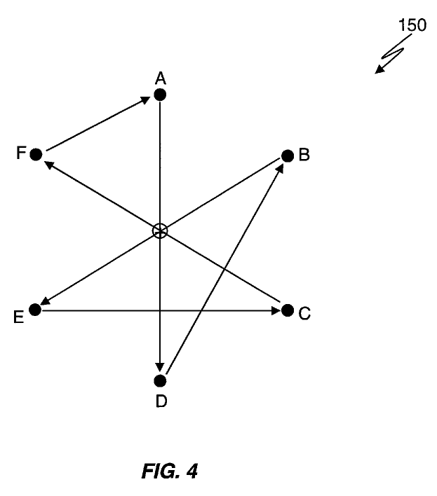

FIG. 4 shows one example of a conical scan pattern 150 executed in a non-sequential order. Instead of sequentially moving the position of the beam 130 from position A to position B to position C, etc., as discussed above, traversing the conical scan pattern 150 in a “non-sequential” order refers to moving the position of the beam 130 in a space order that is out of sequence from the conventional circular order of the conical scan pattern 150. The receiver, e.g., the mobile station 120 receives the signal and measures the corresponding signal strength at two or more of the beam positions. Moving the beam according to the non-sequential order effectively time order scrambles the signal strength measurements. When the signal strength measurements are time-order unscrambled, multiplicative noise due to slow fading is effectively time-order scrambled, which spreads the spectrum of the multiplicative noise. The reordered signal strength measurements correspond to a sequential order of the conical scan pattern 150, which has a “smooth” and therefore spectrally compact variation. For example, the non-sequential order of FIG. 4 moves the beam position from position A to D to B to E to C to F before returning to position A. Thus, the mobile station 120 receives the signal and makes signal strength measurements in an A, D, B, E, C, F order. To spread the slow fading noise and unscramble the signal strength measurements, the mobile station 120 may reorder the signal strength measurements so that the signal strength measurements are arranged in an A, B, C, D, E, F order, and thus correspond to a narrowband sinusoidal signal. Alternatively, the mobile station 120 may reorder the signal strength measurements in an F, E, D, C, B, A order, which is also spectrally compact and corresponds to a time-reversed narrowband sinusoidal signal.

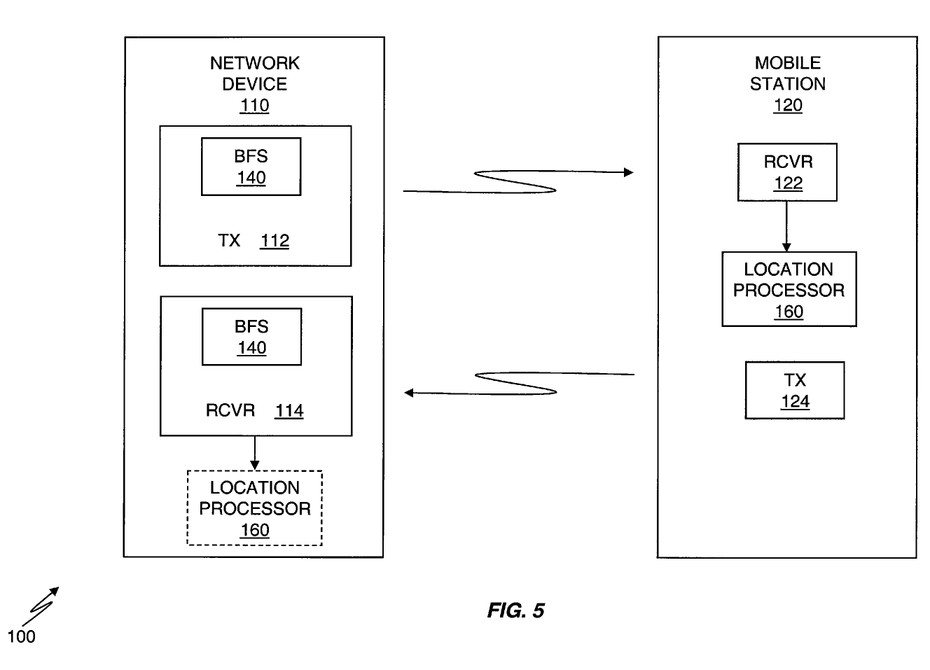

FIG. 5 shows a block diagram representation of the wireless network 100. The network device 110 comprises a transmitter 112, receiver 114, and an optional location processor 160. Mobile station 120 comprises a receiver 122, transmitter 124, and location processor 160. The network device 110 uses beamforming system 140 to generate a reception or transmission beam 130 that traverses a conical scan pattern 150 in a desired order, such as a non-sequential order. A conical scan pattern 150 is characterized by the beam direction offsets being of a constant radial displacement from the nominal beam center. While this is the simplest scan pattern for relating a location of a mobile station 120 to measured signal strength variations, other scan patterns having irregular radial displacements may be used. The advantage of a conical scan pattern is that the amplitude of the measured signal strength variations relative to the scan pattern are directly proportional to the distance of the mobile station 120 from the nominal center of the beam 130, while the phase of the measured signal strength measurement variations relative to the scan pattern are directly related to the bearing of the mobile station 120 from the nominal center. More particularly, the location of the mobile station 120 in Cartesian coordinates (X, Y) relative to the nominal center of a satellite antenna beam 130 may be given by:

X=ax

Y=by (1)

In Equation (1), a and b represent constants of proportionality, x represents the cosine component of the measured signal strength variation at the conical scan frequency, and y represents the sine component of the measured signal strength variation at the conical scan frequency. The proportionality constants may be determined by calibration, e.g., by performing measurements with mobile stations or fixed calibration receivers at known locations. When the scan pattern comprises a circular scan pattern, e.g., a conical scan pattern, a and b are the same. However, when the scan pattern is non-circular, e.g., when the scan pattern has an elliptical cross-section, a and b are different. In this case, X aligns with the major axis of the ellipse and Y aligns with the minor axis when a>b, and Y aligns with the major axis of the ellipse and X aligns with the minor axis when a<b. It will be appreciated that the location of the mobile station 120 may also be represented by polar coordinates having an amplitude and phase, where the amplitude directly relates to the distance between the mobile station 120 and the nominal center, and the phase directly relates to the direction or bearing of the mobile station 120 relative to the nominal center. Further, it will be appreciated that the location of a mobile station 120 relative to a nominal center of a terrestrial antenna beam 130 may also be determined based on Equation (1).

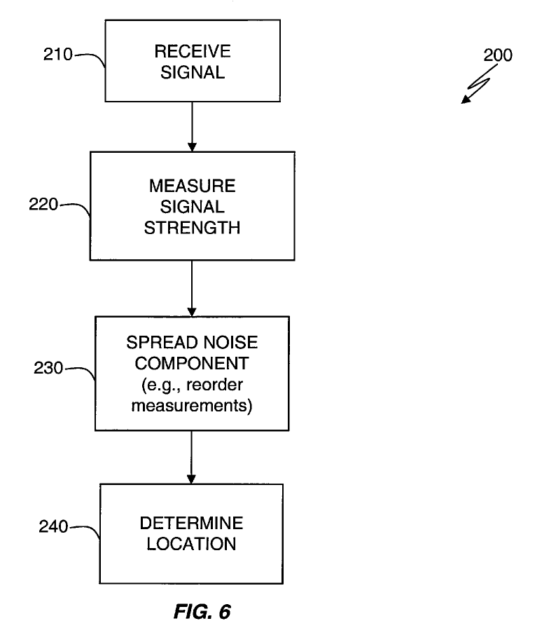

FIG. 6 shows one exemplary process 200 for determining the location of the mobile station 120 using the location processor 160. The transmitter 140 in the network device 100 transmits a signal to the mobile station 120 as a position of a transmission antenna beam 130 traverses a conical scan pattern 150 in a non-sequential order. The movement of the transmission antenna beam 130 may be synchronized to one or more of the above mentioned signal features, e.g., frame, timeslot, etc. The receiver 122 in the mobile station 120 receives the signal at each beam position (block 210). Based on timing signals received from the network device 110, the receiver 122 may synchronize the step of receiving the signals with one or more of the signal features. The location processor 160 processes the received signal to determine the location of the mobile station 120 (blocks 220-240).

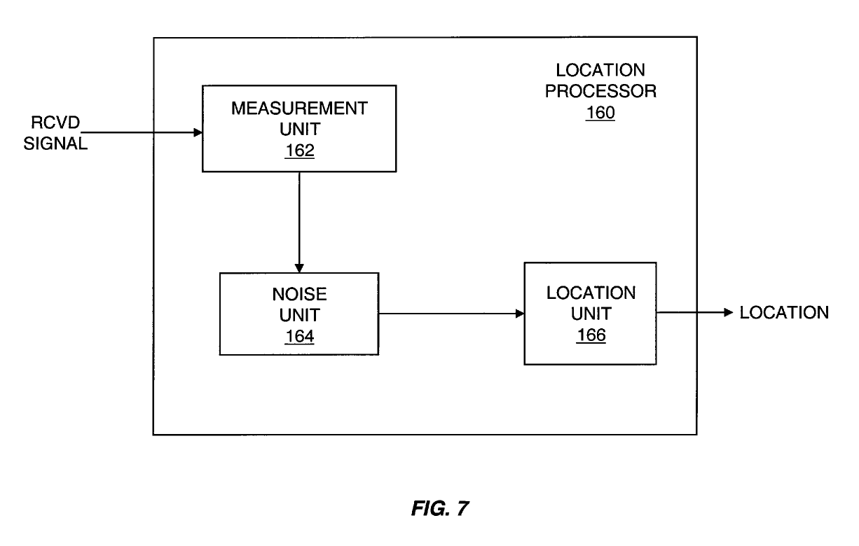

One exemplary location processor 160 comprises a measurement unit 162, noise unit 164, and location unit 166, as shown in FIG. 7. The measurement unit 162 measures the strength of the received signal at two or more of the beam positions (block 220). Noise unit 164 adjusts the signal strength measurements by spreading the multiplicative noise (block 230), e.g., by reordering the signal strength measurements. The location unit 166 determines the mobile station location based on the adjusted signal strength measurements (block 240).

In one embodiment, the location unit 166 determines the location of the mobile station 120 by correlating the reordered signal strength measurements with a reference signal. The reference signal, for example, may comprise a sequence of complex samples at angular positions along a complex sinusoid e^{jkT}. The complex samples represent the known beam displacement at regular intervals kT, where k=1, 2, 3, etc., and T represents the time interval for which the beam 130 dwells at a particular position, e.g., during a TDMA time slot or TDMA frame period. The correlation provides signal strength variations having an amplitude and phase component. Location unit 166 uses the amplitude and phase components of the signal strength variations to determine the location of the mobile station 120, where the amplitude yields a distance of the mobile station 120 from the nominal center of the beam 130 and the phase yields an angular direction relative to the nominal center of the beam 130. When the reference signal comprises a narrow-band sine wave complex sinusoid corresponding to a conical scan pattern, the correlation may be obtained by performing a Fourier transform of the reordered signal strength measurements. The fundamental component of the result is then extracted to yield the amplitude and phase indicative of the mobile station's location relative to a nominal center of the beam 130.

Consider the following example, where network device 110 transmits a waveform conforming to the GMR2 standard, which is a derivative of the GSM cellular telephone standard. The GMR2 standard uses 120 ms multiframes, each multiframe comprising 13 TDMA frames, and each TDMA frame comprising 16 timeslots. Frames 1-12 carry traffic to designated mobile stations 120, while frame 13 carries the Slow Associated Control Channel (SACCH) data. In one mode, the 12×16-slot traffic frames may be formatted as 6, 32-slot traffic frames. One mobile station 120 normally listens to one of these 32 slots per frame in each of the 6 frames, and one of the 16 slots in the SACCH frame. At other times, the mobile station 120 may also listen to slots on different frequencies that may be in use in neighboring beams in order to make neighboring beam measurements.

Table 1 shows how a non-sequential order for traversing the conical scan pattern 150 shown in FIG. 4 may be used with the above-described GMR2 waveform.

TABLE 1

| | | Beam Position Relative to |
|---|---|---|
| Frame No. | Beam Position Designation | Nominal Center |
| 1 | A | 0° |
| 2 | D | 180° |
| 3 | B | 60° |
| 4 | E | 240° |
| 5 | C | 120° |
| 6 | F | 300° |
| SACCH | | 0°, 180°, 270°, 90°, 225°, 45°, |
| | | 315°, 135° |

In Table 1, the frame number refers to the 32-slot frames. The beam position refers to the direction of the offset relative to a nominal center position of the beam 130, and should not be confused with the amount of beam offset. For example, a beam position of 180° refers to a southerly offset relative to the nominal center. The beam offset amount is generally equal for all beam positions, and should be as large as possible consistent with the signal loss due to the pointing error being small enough to be considered negligible, e.g., less than 1 dB. To avoid this signal loss, it may be desirable to implement beam scanning only when determining the location of the mobile station 120. Two SACCH messages occupy one slot in each of eight sequential SACCH frames. Each SACCH message period is 4×120 ms=480 ms, and the pair occupies 960 ms. Thus, a conical scan pattern 150 associated with the SACCH may have 8 beam positions (e.g., 0°, 45°, 90°, 135°, 180°, 225°, 270°, 315°). Table 1 also shows one exemplary non-sequential traversal order for the 8 slots of two SACCH messages. SACCH messages are transmitted at a constant power, which is typically higher than the average power of a power-controlled traffic slot. Therefore, power control-induced variations are not an issue for the SACCH signal. Similarly, traffic slots destined for a particular mobile station 120 are transmitted at a constant power in the 6 (or 12) frames between two SACCH frames, and therefore, power-control induced variations are not an issue if cycling through the conical scan pattern is time-aligned with these slots.

The pattern of Table 1, when reordered as frame number 1, 3, 5, 2, 4, 6 produces a regular pattern of signal strength measurements at 0°, 60°, 120°, 180°, 240°, and 300°, which represent samples of a regular, repetitive sinusoidal cycle. Thus, when reordered, the signal strength variations represented by the signal strength measurements exhibit a sinusoidal characteristic. Likewise, the SACCH pattern when reordered becomes 0°, 45°, 90°, 135°, 180°, 225°, 270°, 315°, which gives a sinusoidal representation of the signal strength variations over two SACCH message periods of 480 ms each, or 1 s in total. While reordering the signal strength measurements has the effect of unscrambling the signal strength variations caused by the non-sequential beam scanning process, reordering randomizes the signal strength variations due to other causes, such as multiplicative noise due to slow fading, which spreads the spectrum of the noise.

The beam positions in Table 1 may be produced by the beamforming system 140 shown in FIG. 2A or 2B. Like with the sequential implementation of conventional systems, the non-sequential implementation of the present invention holds the beam position constant over a frame period, but changes the beam position between frames or timeslots. The set of six complex coefficient matrices to produce the entire conical scan pattern of period 6 may be pre-computed and stored. Likewise, 8 complex coefficient matrices may be pre-computed and stored to give the desired SACCH non-sequential order.

The network device 110 may alternatively determine the location of the mobile station 120. In one embodiment, the mobile station 120 may transmit the signal strength measurements to the network device 110, either before reordering or after reordering. A location processor 160 in the network device 110 may then reorder the received signal strength measurements (if necessary) and determine the location of the mobile station 120 based on correlations between the reordered signal strength measurements and the scan pattern.

In another embodiment, the network device 110 may include a location processor 160 that determines the location of the mobile station 120 based on a signal received from the mobile station 120. In this embodiment, beamforming system 140 generates a reception antenna beam 130 that traverses the conical scan pattern 150 in the non-sequential order as the mobile station 120 transmits the signal. FIG. 2B shows one exemplary beamforming system 140 for generating the reception antenna beam 130. Receiver 114 receives the signal from the mobile station 120, and the location processor 160 in the network device 110 processes the received signal at two or more of the beam positions to determine the location of the mobile station 120, as discussed above.

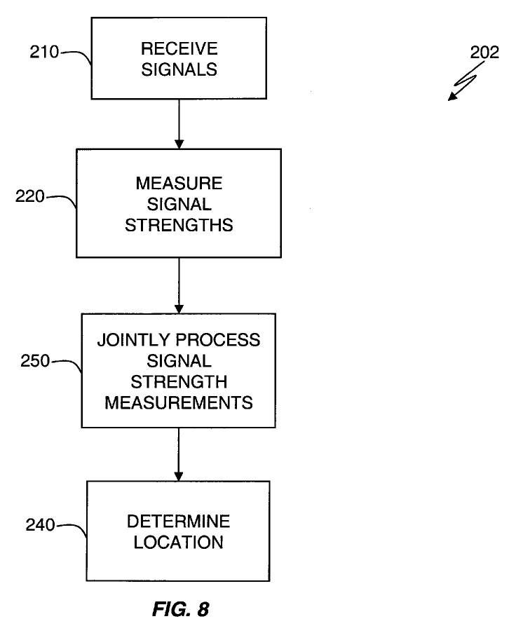

FIG. 8 shows a location determining process 202 for another exemplary embodiment that relies on a plurality of different frequency components to determine the location of the mobile station 120. For simplicity, the following describes this embodiment in terms of two or four signals, each of which has a different frequency component. This embodiment, however, applies to any number of signals, including a single signal having two or more frequency components, or many frequency components, such as the sub-carriers of an OFDM signal.

The network device 110 generates multiple signals, each having different frequencies. The mobile station 120 receives the signals via respective transmission beams 130 as the position of each of the different transmission beams 130 traverses different conical scan patterns 150 (block 210). In some embodiments, the different conical scan patterns 150 may be derived from a common conical scan pattern 150 executed in different scanning orders (block 210). The mobile station 120 measures the strength of the received signals at two or more of the beam positions for each frequency component (block 220). The mobile station 120 then jointly processes two or more signal strength measurements made on the two or more frequencies to determine a combined correlation (block 250), and determines the location of the mobile station 120 based on the combined correlation.

In a first embodiment, the mobile station 120 jointly processes the signal strength measurements by correlating the signal strength measurements on each frequency with the scan pattern 150 for that frequency, and then adding the correlations obtained for the different frequencies. For example, if the scan pattern 150 for one frequency is a time-order-scrambled conical scan pattern 150, the measurements for that frequency are first re-ordered in sequential order and then Fourier-analyzed to determine the complex value of the fundamental component at that frequency. Fundamental components obtained in this way from the signal strengths measured on each frequency are then complex added to produce a combined correlation, the amplitude and phase of which respectively represent the distance and bearing of the mobile station 120 from the nominal beam center. This embodiment assumes that the nominal beam center is chosen to be the same for each scan pattern 150.

In some implementations, a weighting factor may first be applied to some or all of the fundamental components to account for the possibility that one frequency may yield a more reliable result than another. For example, the DC term from a Fourier analysis represents the mean signal strength for a given frequency. If the mean signal strength is lower for one frequency than for another, the frequency having the lower mean signal strength may be given a proportionally lower weighting factor. Alternatively, Fourier components other than the fundamental component may be used to weight the complex addition appropriately so as to give more weight to less noisy signal strength measurements.

In a second embodiment, different frequency components traverse a common conical scan pattern 150 in different orders. To determine its location, the mobile station 120 jointly processes the signal strength measurements by combining the signal strength measurements having corresponding beam positions. For example, the beam 130 may be “due North” of the nominal beam center at different times for different frequencies. Combining the signal strength measurements for the different frequencies associated with the due North position produces a net signal strength for the due North position. After obtaining net signal strengths in this way for two or more beam positions, the net signal strengths are correlated with the common conical scan pattern 150, for example by Fourier analysis, to obtain a combined correlation with the scan pattern. The amplitude and phase of the combined correlation correspond to distance and bearing of the mobile station 120 from the nominal beam center. It will be appreciated that any signal strength measurements associated with non-sequential scanning orders may be reordered before being combined with other signal strength measurements to spread the multiplicative noise.

A third embodiment may be used when the nominal beam center differs for at least some frequency components. In this case, a location of the mobile station 120 is found by determining the location from the signal strength measurements for each frequency separately and then averaging the determined locations. For example, first and second preliminary locations may be determined based on the signal strength measurements for signals having first and second frequency components using any method described above. The final mobile station location may be determined by averaging the first and second preliminary locations.

It will be appreciated that in each of the three embodiments described above, the location of the mobile station 120 and optionally velocity and higher order derivatives of location may be averaged over several measurements by Kalman filtering, as described in the above-incorporated '071 patent.

The advantage of multi-frequency location determination is most easily understood from the method described under the above-described second embodiment. However, it will be appreciated that all of the above-described embodiments are mathematically equivalent in terms of this advantage. If the times at which the beam 130 is at a given position are different for each frequency component, when the measurements are combined for the same beam position, the net combined signal strength resulting for that beam position will be the sum of signal strengths made over the entire period. Thus, any variation of signal strength over that period will be averaged to the same value for each beam position, at least with the assumption that the signal strength variations due to slow fading are the same for each frequency component. Thus, the effect of non-frequency-selective slow fading is often eliminated completely. If the fading is not the same on each frequency but is uncorrelated, the advantage will be a reduction of the fading error by a factor of the square root of the number of frequency components and by a factor related to the spectral spreading of the multiplicative fading noise when time-order scrambled conical scanning is employed.

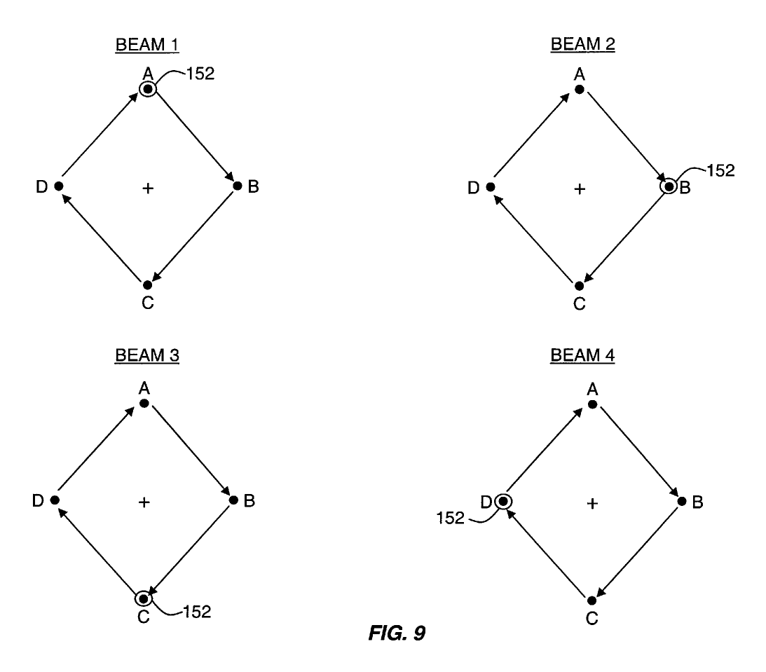

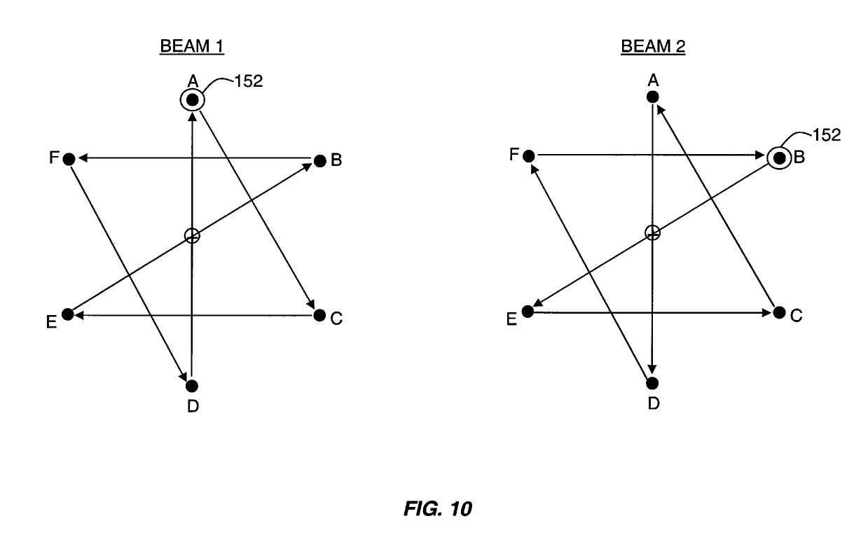

Thus, in general, each beam 130 traverses the different scanning patterns 150. The different scanning patterns 150 may comprise any mutually orthogonal scanning patterns 150 that prevent the different beams from being in the same position at the same time. Alternatively or in addition, the different scanning patterns 150 may be generated by executing a common scanning pattern 150 in different scanning orders, with different phase or time offsets, and/or at different scanning frequencies. In one embodiment, shown in FIG. 9, four beams traverse a common conical scan pattern 150 in the same order but start at different starting positions 152, and therefore, are offset in phase or time. In this example, the start position 152 for the first beam is position A, the start position 152 for the second beam is position B, the start position 152 for the third beam is position C, and the start position 152 for the fourth beam is position D. In another embodiment, shown in FIG. 10, the first and second orders comprise different non-sequential scanning orders. In this example, the first and second scanning orders comprise first and second non-sequential orders, where the start position 152 for the first beam is position A and the start position 152 for the second beam is position B.

In one embodiment, the mobile station 120 receives the plurality of signals as the beams traverse the conical scan 150. The measurement unit 162 of the location processor 160 makes signal strength measurements of the received signal at two or more of the beam positions, the noise unit 164 reduces the noise, such as noise due to slow fading, in the signals, and the location unit 166 determines the mobile station location based on the noise reduced signal strength measurements. The noise unit 164 may reduce the noise by jointly processing the signal strength measurements corresponding to different frequency components to determine a combined correlation as discussed above, and the location unit 166 may determine the location of the mobile station 120 based on the combined correlation. For example, the location unit 166 may determine the location based on the amplitude and the phase of the combined correlation. The amplitude indicates the distance of between mobile station 120 and the nominal center of beam 130, and the phase indicates the direction of mobile station 120 relative to the nominal center.

To illustrate, consider the following example. Table 2 shows how the mobile station 120 receives each signal in different transmission periods based on the scanning orders shown in FIG. 9. Table 3 shows how the different signals received in the different transmission periods shown in Table 2 align according to the beam positions.

TABLE 2

Transmission Period

| Beam/Frequency | T1 | T2 | T3 | T4 |
|---|---|---|---|---|
| 1 | A | B | C | D |
| 2 | B | C | D | A |
| 3 | C | D | A | B |
| 4 | D | A | B | C |

TABLE 3

Beam Position

| Beam/Frequency | A | B | C | D |
|---|---|---|---|---|
| 1 | T1 | T2 | T3 | T4 |
| 2 | T4 | T1 | T2 | T3 |
| 3 | T3 | T4 | T1 | T2 |
| 4 | T2 | T3 | T4 | T1 |

When the fading noise affects all frequencies equally, combining the signal strength measurements corresponding to a particular beam position for each of the beam positions averages out the fading noise, and therefore, improves the accuracy of any subsequent location calculations. In one embodiment, the signal strength measurements may be combined by first extracting the fundamental component of the cyclic variation by, for example, Fourier analysis, and then adding the result for each frequency.

In some cases, it may not be convenient or possible to construct a receiver capable of simultaneously making signal strength measurements on several different frequency channels. This may be addressed by setting the different frequencies to different spectral components of a signal within a single channel. In this scenario, a single channel receiver will suffice for capturing the different signals. An Orthogonal Frequency Division Multiplexing (OFDM) signal represents one exemplary signal that automatically comprises multiple sub-carriers. Thus, an implementation of the above-described multi-frequency process constructs an OFDM signal within a single radio frequency channel. Subjecting the spectral components of the OFDM signal to different beamforming matrices, and changing the matrices in a scanning order that differs in phase, frequency, and/or pattern, as described above, creates a different beam for each of the sub-carriers. This enables the mobile station 120 to measure the signal strength variation of each OFDM sub-carrier. Combining the signal strength measurements of the corresponding sub-carriers of each beam position removes noise or inaccuracies due to flat fading.

In the case of an OFDM communications signal, different frequency components are naturally present in the form of distinct sub-carriers. In non-OFDM cases, the signal may not have specific distinct frequency components, and a conventional receiver for such signals may not normally be constructed to make simultaneous signal strength measurements of several different frequency components. Nevertheless, by choosing, as the different frequency components, the different spectral components of a signal within a single channel, and arranging that the antenna beam directions are wobbled differently for each spectral component, a receiver may be constructed to provide the same advantage for location determination as in the OFDM case. In this scenario, a single channel receiver will suffice for capturing the different spectral components of the signals.

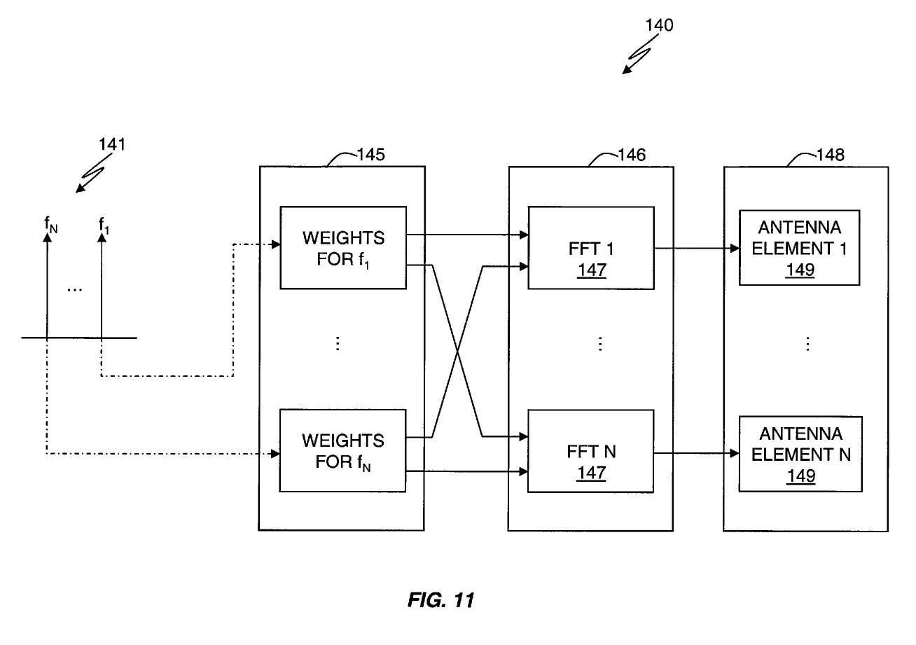

FIG. 11 shows a block diagram of an exemplary beamforming system 140 for transmitting an OFDM signal to a single location (e.g., the mobile station 120) while the different sub-carriers of the OFDM signal are subjected to different beam positions of a conical scan pattern 150 in different scanning orders. Each OFDM sub-carrier may comprise any sequence of digital symbols. However, when using the OFDM signal to determine the location of the mobile station 120, it may be preferable to use a predetermined sequence of digital symbols known to the receiver. The predetermined sequence may be different for each OFDM sub-carrier. Further, the predetermined sequence may have a known time-relationship to the beam positions, e.g., the same repetition period. The beamforming system 140 of FIG. 11 comprises a set of weighting elements 145, a multiplexer system 146, and an antenna array 148 comprising a plurality of antenna array elements 149. In the case that the antenna array 148 is remote from the beamforming system 140, as in a satellite system that uses a ground-based beamforming system 140 described in the above-mentioned U.S. patents to Applicant, a feederlink multiplexer (not shown) may follow multiplexer and transceiver system 146 to convey multiple beamformer outputs (or inputs) to the respective antenna elements. A processor (not shown) generates an OFDM signal or symbol stream 141 having two or more sub-carriers. Each sub-carrier of the OFDM signal 141 is weighted by the corresponding weighting element from the set of weighting elements 145. The weights in the weighting elements determine the phase and amplitude with which each OFDM sub-carrier will be distributed across the antenna array elements 149. It will be appreciated that the number of antenna array elements 149 is not required to equal the number of OFDM sub-carriers, as shown in FIG. 11.

Weighted OFDM sub-carriers targeted to be transmitted by the same antenna element 149 are collected by a multiplexing element 147 in the multiplexer system 146. Multiplexing element 147 may comprise, for example, a plurality of FFT elements, e.g., FFT processors, DFT processors, windowed FFT processors, or any other processor that translates each weighted OFDM spectral component to its respective sub-carrier frequency and combines the signals at all sub-carrier frequencies for a given antenna element 149 to form the OFDM signal for that antenna element 149. This can include up-shaping and down-shaping using cyclic pre-fixes or post-fixes to obtain a desirable spectrum, as is known in the art of pulse-shaped OFDM. By choosing the weighting elements 145 appropriately, each OFDM sub-carrier is beamformed to a different desired beam position according to the conical scan pattern and the corresponding scanning order. The scanning order for each OFDM sub-carrier is preferably different, as discussed above, so that each transmission period is equally represented across the different OFDM sub-carriers. This provides combined signal strengths that are immune to slow fading.

The beamforming system 140 of FIG. 11 forms the OFDM signal in a plurality of beams for a single mobile station 120. Multiple OFDM signals may be transmitted in different directions by replacing the set of weighting elements 145 with beamforming coefficient matrices and matrix multiplication, where each matrix multiplication has an input from multiple OFDM signals, such as the OFDM signal shown in FIG. 11.

An OFDM signal constructed as disclosed above may only need to be transmitted when it is desired to determine the location of a mobile station 120. Reciprocally, the mobile station 120 may transmit an OFDM signal containing a set of distinguishable sub-carriers, and the network device 110 may receive each sub-carrier using a different receiving beam traversing a conical scan pattern 150 in a different scanning order. For example, by reversing the direction of the arrows in FIG. 11, OFDM reception beamforming is obtained in which each OFDM sub-carrier is received with a different beam 130, the direction offset of which is separately defined by traversing a conical scan pattern 150 in a scanning order particular to the sub-carrier. In this way, the network device 110 may determine the location of a mobile station 120 that is passively transmitting an OFDM signal. It will be appreciated that the mobile station 120 may alternatively transmit the signal strength measurements to the network device 110 so that the network device may make the final mobile station location calculations.

When using a multi-frequency signal, such as an OFDM signal, that contains distinguishable sub-carriers, the antenna directionality for either transmission or reception beams may be varied in a series of time steps that are different for each sub-carrier. Receiver measurements for each sub-carrier and time step may then be collected in memory to form a two-dimensional array of samples. A two-dimensional Fourier transform may be performed on the array of samples. The pattern of antenna directionality variation may be chosen so that its two-dimensional Fourier transform has a single non-zero component. The order of the frequency and time elements of the pattern are preferably order-scrambled in the time dimension, the frequency dimension, or both, and then the signal strength measurements are stored in the two-dimensional array in an unscrambled order. This has the effect of scrambling the order in which errors due to signal variations in time or frequency due to other causes are located in the array. Such errors are then distributed between all Fourier components after the two-dimensional Fourier transform, such that the error is reduced on the component that yields the desired information.

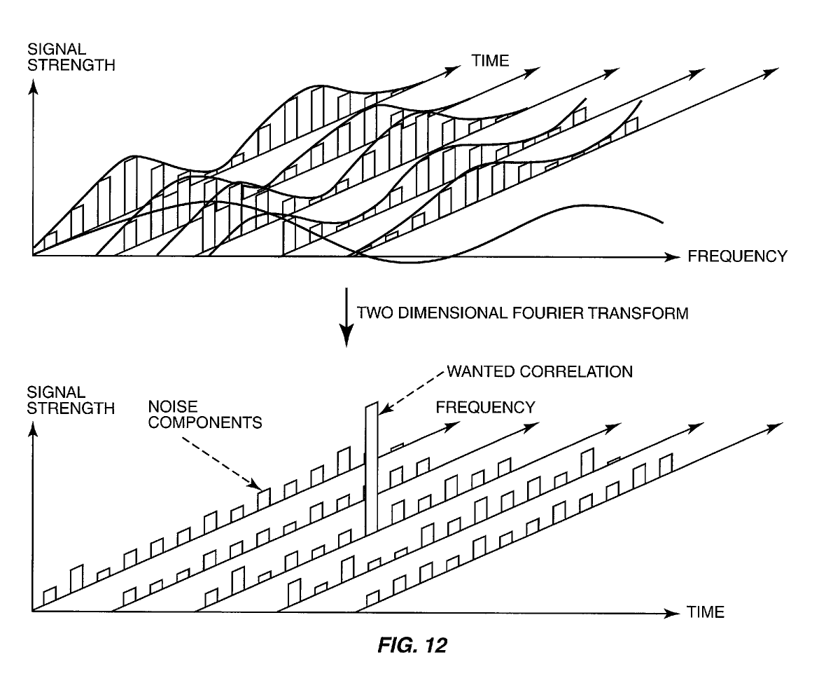

FIG. 12 illustrates a set of signal strength measurements made at different times on different frequencies, plotted as a two-dimensional array. The top graph in FIG. 12 shows the time variation of the beam positions for five frequencies. The top graph also shows an exemplary sinusoid along the frequency axis that represents the signal strength measurements from all frequency components at one instant of time. When the time variation of the beam positions after unscrambling the order is a first sinusoid, and the sinusoid is shifted from one frequency to the next (after ordering the frequencies along the frequency axis appropriately, if necessary), then the two-dimensional Fourier transform will exhibit a strong peak at a specific point in the transform plane while noise components will be distributed randomly across all components in the two-dimensional transform plane, as shown in the bottom graph in FIG. 12. It may be realized that the Fourier transform will have components above the wanted conical scan frequency (harmonics thereof) due to processing multiple samples per conical scan cycle, and will also have components below the conical scan frequency (sub-harmonics thereof) if data spanning several more than one conical scan cycle are processed. Just as an error due to a smooth fading variation could be transformed by time-order unscrambling to a non-smooth fading variation, thereby spreading the error spectrum away from the wanted conical scan component, so can an error due to a smooth signal strength variation with frequency be transformed by frequency-order scrambling and unscrambling into a non-smooth frequency variation, thereby spreading the error spectrum away from the wanted conical scan component. Thus, errors due to propagation path variations in both time and frequency may be reduced by scrambling the conical scan pattern in time and using a progressively time-shifted version of the scrambled conical scan on different frequencies taken in a non-sequential frequency order. After re-ordering the frequencies, the scrambled conical scan pattern once more appears to be progressively time-shifted from one frequency to the next, and after unscrambling the conical scan pattern on each frequency, the sequential conical scan ordering is restored on each, while spectrally spreading the fading noise.

The above described satellite antenna arrays may utilize beamforming signals created in the satellite or at a ground station associated with the satellite. The above-incorporated U.S. patents describe the operation of exemplary antenna arrays located on an orbiting satellite, where the signals from each antenna element may be brought down to the ground station coherently or communicated from the ground station to the satellite-borne antenna array coherently.

While the above describes the invention in terms of satellite antenna beams that traverse a conical scan pattern, it will be appreciated that a terrestrial network device, such as a radio base station, may also be used to generate the electronically steerable antenna beam 130. In this scenario, pairs of vertical collinear antenna arrays may be used to steer the antenna beam 130 in the desired manner. For example, pairs of vertical collinear arrays closely spaced horizontally and connected to phased transmitters and/or diversity receivers may be used to control the azimuthal directivity of a transmission or reception beam. In addition, further pairs with a somewhat larger vertical spacing may be used to control elevation directivity, which translates to moving the beam center along a radial line away from the antenna tower. Thus, such an antenna arrangement may be used to produce a steerable antenna beam 130 for a terrestrial network device 110.

The above provides a method and apparatus for determining a location of a mobile transmitter or a mobile receiver (mobile station 120) using signals that traverse a conical scan pattern in a known order. Such location information may be used to improve communications that require accurate location information.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method for determining a location of a mobile station comprising:
receiving a signal from a remote station within an antenna beam, wherein a position of the beam traverses a scan pattern in a non-sequential order;
making a signal strength measurement of said signal at a plurality of the beam positions;
spreading a noise component of said signal strength measurements; and
after spreading the noise component, determining a location of the mobile station based on the signal strength measurements.

2. The method of claim 1 wherein spreading the noise component comprises reordering the signal strength measurements to correspond to sequentially ordered beam positions of the scan pattern.

3. The method of claim 2 wherein determining the location of the mobile station comprises:
correlating the reordered signal strength measurements with a reference signal; and
determining the location of the mobile station based on the correlation.

4. The method of claim 3 wherein correlating comprises performing a Fourier transform on the reordered signal strength measurements.

5. The method of claim 3 wherein determining the location comprises:
determining an amplitude and a phase of the signal strength measurements based on the correlation; and
determining the location of the mobile station relative to a nominal center of the beam based on the amplitude and phase.

6. The method of claim 5 wherein determining the location based on the amplitude and phase comprises:
determining a distance between the mobile station and the nominal center of the beam based on the amplitude; and
determining a direction of the mobile station relative to the nominal center of the beam based on the phase.

7. The method of claim 1 further comprising varying the beam position between time slots or traffic frames of the signal.

8. The method of claim 1 wherein the remote station comprises the mobile station, wherein the beam comprises a reception beam configured to receive the signal from the mobile station at a network device, and wherein the network device determines the location of the mobile station based on the signal strength measurements.

9. The method of claim 1 wherein the remote station comprises a network device, and wherein the beam comprises a transmission beam configured to transmit the signal from the network device to the mobile station.

10. The method of claim 9 wherein determining the location comprises determining the location based on the signal strength measurements at the mobile station.

11. The method of claim 9 further comprising transmitting the signal strength measurements from the mobile station to the network device, wherein determining the location comprises determining the location at the network device based on the signal strength measurements received at the network device.

12. The method of claim 9 further comprising maintaining the transmitted signal at a generally constant mean transmission power for the plurality of the beam positions.

13. The method of claim 9 further comprising:
maintaining the transmission beam at a generally constant position during a timeslot or traffic frame of the signal; and
varying the position of the transmission beam between transmitted timeslots or traffic frames of the signal.

14. The method of claim 9 further comprising synchronizing the step of receiving the signal at the mobile station with one or more features of the signal.

15. A location processor to determine the location of a mobile station based on a signal received from a remote station within an antenna beam, wherein a position of the beam traverses a scan pattern in a non-sequential order, the location processor comprising:
a measurement unit configured to make a signal strength measurement of said received signal at a plurality of the beam positions;
a noise unit connected to an output of the measurement unit and configured to spread a noise component of the signal strength measurements; and
a location unit configured to determine the location of the mobile station based on the signal strength measurements output by the noise unit.

16. The location processor of claim 15 wherein the noise unit is configured to reorder the signal strength measurements.

17. The location processor of claim 16 wherein the location unit comprises:
a correlator to correlate the reordered signal strength measurements with a reference signal; and
a location calculator to determine the location of the mobile station based on the correlation.

18. The location processor of claim 16 wherein the correlator is configured to perform a Fourier transform on the reordered signal strength measurements.

19. The location processor of claim 16 wherein the location calculator is configured to:
determine an amplitude and a phase of the signal strength measurements relative to a nominal center of the beam based on the correlation; and
determine the location of the mobile station based on the amplitude and phase.

20. The location processor of claim 19 wherein the location calculator determines the location based on the amplitude and phase by:
determining a distance between the mobile station and the nominal center of the beam based on the amplitude; and
determining a direction of the mobile station relative to the nominal center of the beam based on the phase.

21. The location processor of claim 15 wherein the beam position varies between time slots or traffic frames of the received signal.

22. The location processor of claim 15 wherein the remote station comprises the mobile station, wherein the location processor is disposed in a network device, and wherein the beam comprises a reception beam configured to receive the signal from the mobile station at the network device.

23. The location processor of claim 15 wherein the remote station comprises a network device, and wherein the beam comprises a transmission beam configured to transmit the signal from the network device to the mobile station.

24. The location processor of claim 23 wherein at least a portion of the location processor is disposed in the mobile station.

25. The location processor of claim 23 wherein a mean transmission power associated with the signal transmitted by the transmission beam is kept the same for two or more of the plurality of beam positions.

26. The location processor of claim 23 wherein the position of the transmission beam is generally constant during a timeslot or traffic frame of the signal, and wherein the position of the transmission beam changes between the timeslots or traffic frames.

27. The location processor of claim 23 wherein the measurement unit is further configured to synchronize the step of receiving the signal with one or more features of the signal.

28. A method for transmitting a signal comprising:
generating a signal;
determining a scan pattern for an antenna beam, said scan pattern having a plurality of sequentially spaced beam positions; and
transmitting the signal to a mobile station within the antenna beam as the beam position traverses the scan pattern in a non-sequential order.

29. The method of claim 28 wherein a mean transmission power associated with the signal is kept the same at the plurality of beam positions.

30. The method of claim 28 wherein the beam position is generally constant during a timeslot or traffic frame of the signal, and wherein the beam position changes between the timeslots or traffic frames.

31. A transmitter for transmitting a signal comprising:
a processor to generate a signal and to determine a scan pattern for an antenna beam, said scan pattern comprising a plurality of sequentially spaced beam positions;
a beamformer to generate the antenna beam at a plurality of the beam positions; and
an antenna array configured to transmit the signal within the antenna beam as the beam position traverses the scan pattern in a non-sequential order.

32. The transmitter of claim 31 wherein a transmission power associated with the signal is generally constant at the beam positions.

33. The transmitter of claim 31 wherein the beam position is generally constant during a timeslot or traffic frame of the signal, and wherein the beam position changes between the timeslots or traffic frames.

34. A method for determining a location of a mobile station comprising:
generating a signal;
determining a scan pattern for an antenna beam, said scan pattern having a plurality of sequentially spaced beam positions;
transmitting the signal to a mobile station within the antenna beam as the beam position traverses the scan pattern in a non-sequential order;
receiving the signal at the mobile station;
making a signal strength measurement of the received signal at a plurality of the beam positions of the scan pattern;
reordering the signal strength measurements to spread a noise component in the received signal; and
determining a location of the mobile station based on the reordered signal strength measurements.

35. The method of claim 34 wherein determining the location comprises determining the location of the mobile station at the mobile station based on the reordered signal strength measurements.

36. The method of claim 34 further comprising transmitting the signal strength measurements to the network device, wherein reordering the signal strength measurements comprises reordering the received signal strength measurements at the network device, and wherein determining the location comprises determining the location of the mobile station at the network device based on the reordered signal strength measurements.

37. A wireless network comprising:
a network device comprising:
a processor to generate a signal and to determine a scan pattern for an antenna beam, said scan pattern comprising a plurality of sequentially spaced beam positions;
a beamformer to generate the antenna beam at a plurality of the beam positions; and
an antenna array configured to transmit the signal within the antenna beam as the beam position traverses the scan pattern in a non-sequential order; and
a mobile station comprising:
a receiver to receive the signal;
a measurement unit to make a signal strength measurement of the received signal at a plurality of the beam positions of the scan pattern;
a noise unit to reorder the signal strength measurements to spread a noise component in the received signal; and
a location unit to determine a location of the mobile station based on the reordered signal strength measurements.

38. A method for determining a location of a mobile station, the method comprising:
determining a first scan pattern comprising a plurality of sequentially ordered beam positions arranged about a first nominal center;
determining a second scan pattern comprising a plurality of sequentially ordered beam positions arranged about a second nominal center;
receiving a first signal associated with a first frequency from a remote station within a first beam, wherein a position of the first beam traverses the first scan pattern;
receiving a second signal associated with a second frequency from a remote station within a second beam, wherein a position of the second beam traverses the second scan pattern;
making a first signal strength measurement of said first signal and a second signal strength measurement of said second signal at a plurality of the beam positions of the first and second scan patterns;
jointly processing the signal strength measurements made on two or more of the beam positions on said first and second frequencies to determine a combined correlation with said scan patterns; and
determining the location of the mobile station based on the combined correlation.

39. The method of claim 38 wherein the first and second scan patterns are mutually orthogonal.

40. The method of claim 38 wherein the first and second scan patterns comprise a common scan pattern executed at different scan frequencies.

41. The method of claim 38 wherein the first and second scan patterns comprise a common scan pattern executed in first and second orders, respectively.

42. The method of claim 41 wherein the second order is offset from the first order by a predetermined phase or time.

43. The method of claim 41 wherein the first order comprises a non-sequential order.

44. The method of claim 43 further comprising spreading a noise component of the first signal by reordering the first signal strength measurements.

45. The method of claim 38 wherein determining the location comprises determining the location of the mobile station based on a Fourier transform of the signal strength measurements.

46. The method of claim 38 wherein jointly processing comprises, for each of the two or more beam positions in the scan patterns, adding the corresponding first and second signal strength measurements to reduce a noise component common to the first and second signal strength measurements.

47. The method of claim 38 wherein determining the location comprises:
determining an amplitude and a phase of the combined correlation; and
determining the location of the mobile station relative to a nominal center of the beam based on the amplitude and phase.

48. The method of claim 47 wherein determining the location based on the amplitude and phase comprises:
determining a distance between the mobile station and the nominal center of the beam based on the amplitude; and
determining a direction of the mobile station relative to the nominal center of the beam based on the phase.

49. The method of claim 38 further comprising changing a position of the first and second beams between time slots or traffic frames of the respective first and second signals.

50. The method of claim 38 wherein the remote station comprises the mobile station, wherein the first and second beams comprise respective first and second reception beams configured to receive the respective first and second signals from the mobile station at a network device, and wherein the network device determines the location of the mobile station based on the combined correlation.

51. The method of claim 38 wherein the remote station comprises a network device, wherein the first and second beams comprise respective first and second transmission beams configured to transmit the respective first and second signals from the network device to the mobile station.

52. The method of claim 38 wherein the first and second signals comprise first and second subcarriers of an orthogonal frequency division multiplexing signal.

53. A location processor to determine the location of a mobile station based on first and second signals received from a remote station within respective first and second beams, wherein a position of the first beam traverses a first scan pattern, and wherein a position of the second beam traverses a second scan pattern, the location processor comprising:
a measurement unit configured to make a first signal strength measurement of said first signal and a second signal strength measurement of said second signal at a plurality of the beam positions of said first and second scan patterns;
a noise unit configured to jointly process said first and second signal strength measurements made on two or more of the beam positions to determine a combined correlation with said scan patterns; and
a location unit configured to determine the location of the mobile station based on the combined correlation output by the noise unit.

54. The location processor of claim 53 wherein the first and second scan patterns are mutually orthogonal.

55. The location processor of claim 53 wherein the first and second scan patterns comprise a common scan pattern executed at different scan frequencies.

56. The location processor of claim 53 wherein the first and second scan patterns comprise a common scan pattern executed in first and second orders, respectively.

57. The location processor of claim 56 wherein the second order is offset from the first order by a predetermined phase or time.

58. The location processor of claim 56 wherein the first order comprises a non-sequential order.

59. The location processor of claim 58 wherein the noise unit is further configured to spread a noise component of the first signal by reordering the first signal strength measurements.

60. The location processor of claim 53 wherein the noise unit performs a Fourier transform of said signal strength measurements to determine a combine correlation, and wherein the location unit determines the location of the mobile station based on the combined correlation.

61. The location processor of claim 53 wherein the noise unit adds, for each of the two or more beam positions in the scan patterns, the corresponding first and second signal strength measurements to reduce a noise component common to the first and second signal strength measurements.

62. The location processor of claim 53 wherein the location unit determines the location by:
determining an amplitude and a phase of the combined correlation; and
determining the location of the mobile station relative to a nominal center of the beam based on the amplitude and phase.

63. The location processor of claim 62 wherein the location unit determines the location based on the amplitude and phase by:
determining a distance between the mobile station and the nominal center of the beam based on the amplitude; and
determining a direction of the mobile station relative to the nominal center of the beam based on the phase.

64. The location processor of claim 53 wherein the position for the first and second beams changes between time slots or traffic frames of the respective first and second signals.

65. The location processor of claim 53 wherein the location processor is disposed in a network device and the remote station comprises the mobile station, and wherein the first and second beams comprise first and second reception beams configured to receive the respective first and second signals from the mobile station at a network device.

66. The location processor of claim 53 wherein the remote station comprises a network device, wherein the first and second beams comprise first and second transmission beams configured to transmit the respective first and second signals from the network device to the mobile station.

67. The location processor of claim 53 wherein the first and second signals comprise first and second subcarriers of an orthogonal frequency division multiplexing signal.

68. A method for transmitting a signal comprising:
generating a first signal associated with a first frequency;
generating a second signal associated with a second frequency;
determining first and second scan patterns comprising a plurality of sequentially spaced beam positions;
transmitting the first signal to a mobile station within a first beam as the position of the first beam traverses the first scan pattern; and
transmitting the second signal to a mobile station within a second beam as the position of the second beam traverses the second scan pattern.

69. The method of claim 68 wherein the first and second scan patterns are mutually orthogonal.

70. The method of claim 68 wherein the first and second scan patterns comprise a common scan pattern executed in first and second orders, respectively.

71. The method of claim 68 wherein the second order is offset from the first order by a predetermined phase or time.

72. The method of claim 68 wherein at least one of the first and second orders comprises a non-sequential order.

73. The method of claim 68 wherein the first and second signals comprise first and second subcarriers of an orthogonal frequency division multiplexing signal.

74. A transmitter for transmitting a signal comprising:
a processor configured to:
generate a first signal associated with a first frequency;
generate a second signal associated with a second frequency; and
determine first and second scan patterns comprising a plurality of sequentially spaced beam positions;
a beamformer to generate first and second beams at two or more of the beam positions in the first and second scan patterns, respectively; and
an antenna array configured to:
transmit the first signal within the first beam as the position of the first beam traverses the first scan pattern; and
transmit the second signal within the second beam as the position of the second beam traverses the second scan pattern.

75. The transmitter of claim 74 wherein the first and second scan patterns are mutually orthogonal.

76. The transmitter of claim 74 wherein the first and second scan patterns comprise a common scan pattern executed in first and second orders, respectively.

77. The transmitter of claim 76 wherein the second order is offset from the first order by a predetermined phase or time.

78. The transmitter of claim 76 wherein at least one of the first and second orders comprises a non-sequential order.

79. The transmitter of claim 74 wherein the first and second signals comprise first and second subcarriers of an orthogonal frequency division multiplexing signal.

80. A method for determining a location of a mobile station comprising:
generating a first signal associated with a first frequency;
generating a second signal associated with a second frequency;
determining first and second scan patterns comprising a plurality of sequentially spaced beam positions;
transmitting the first signal to the mobile station within a first beam as the position of the first beam traverses the first scan pattern;
transmitting the second signal to the mobile station within a second beam as the position of the second beam traverses the second scan pattern;
receiving the first and second signals at the mobile station;
making a first signal strength measurement of said first signal and a second signal strength measurement of said second signal at two or more of the beam positions of the first and second scan patterns;
jointly processing said first and second signal strength measurements made on two or more of said beam positions to determine a combined correlation of the signal strength measurements with said scan patterns; and
determining a location of the mobile station based on the combined correlation.

81. The method of claim 80 further comprising transmitting said signal strength measurements to the network device, wherein determining the location comprises determining said combined correlation at the network and determining the location of the mobile station at the network device based on the combined correlation.

82. The method of claim 80 wherein the first and second signals comprise first and second subcarriers of an orthogonal frequency division multiplexing signal.

83. A wireless network comprising:
a network device comprising:
a processor to generate first and second signals associated with respective first and second frequencies, and to determine first and second scan patterns comprising a plurality of sequentially spaced beam positions;
a beamformer to generate first and second beams at two or more of the beam positions in the first and second scan patterns; and
an antenna array to transmit the first signal within the first beam as the position of the first beam traverses the first scan pattern, and to transmit the second signal within the second beam as the position of the second beam traverses the second scan pattern; and
a mobile station comprising:
a receiver to receive the first and second signals;
a measurement unit to make a first signal strength measurement of the first signal and a second signal strength measurement of said second signal at two or more of the beam positions of the first and second scan patterns, respectively;
a noise unit configured to jointly process said first and second signal strength measurements made on two or more of the beam positions to determine a combined correlation with said scan patterns; and
a location unit to determine a location of the mobile station based on the combined correlation.

84. The wireless network of claim 83 wherein the first and second signals comprise first and second subcarriers of an orthogonal frequency division multiplexing signal.
